(19) United States
(12) Patent Application Publication
(10) Pub. No.: US 2009/0023316 A1
(43) Pub. Date: Jan. 22, 2009

(54) LEVER-FITTING TYPE CONNECTOR

(75) Inventors: Toshiharu TAKAHASHI, Makinohara-shi (JP); Motoyoshi SUZUKI, Makinohara-shi (JP); Kenji KAJIKAWA, Fujieda-shi (JP); Akitoshi SAGISAKA, Fujieda-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/146,536

(22) Filed: Jun. 26, 2008

(30) Foreign Application Priority Data
Jul. 17, 2007 (JP) 2007-185668

(51) Int. Cl. H01R 13/62

(52) U.S. Cl. 439/157

(57) ABSTRACT

A housing 12 is connectable to a mating connector, and has inwardly-projecting housing bosses 41a and 41b. A lever 2 includes engagement portions 21a and 21b engageable respectively with the housing bosses 41a and 41b, and a lever boss 21e for retaining engagement with a retaining portion formed on the mating connector. Guide portions 21c and b 21d for guiding the insertion of the lever 2 into the housing 12 are formed at the lever 2, and a relief portion 41c for the passage of the lever boss 21e therethrough during the insertion is formed at the inside of the housing 12. At the time of starting the insertion of the lever 2 into the housing 12, the distance between each guide portion 21c, 21d and the corresponding housing boss 41a, 41b is smaller than the distance between the lever boss 21e and the relief portion 41c.

### BACKGROUND OF THE INVENTION

1. Field of the Invention

This invention relates to a lever-fitting type connector provided with a housing and a lever, and more particularly to a lever-fitting type connector in which the lever can be easily mounted on the housing, the housing being connectable to a mating connector.

2. Description of the Related Art

In one known conventional lever-fitting type connector of this kind, mounting grooves are provided so that a lever can be easily inserted into a housing at the time of mounting the lever on the housing (see Patent Literature 1). Namely, the mounting grooves formed in the lever extend respectively from engagement holes to peripheral edge portions of the lever along a direction of inserting of the lever. When the lever is mounted on the housing, housing bosses formed on the housing and serving as an axis of pivotal movement of the lever are engaged respectively in the engagement holes.

When inserting the lever into the housing, first, the worker introduces the housing bosses respectively into inlets of the mounting grooves formed respectively at the peripheral edge portions of the lever. Then, the worker pushes the housing bosses deep into the respective mounting grooves, and fits the housing bosses into the respective engagement holes provided respectively at inner ends of the mounting grooves, thus completing the insertion of the lever into the housing.

There is known another conventional lever-fitting type connector employing lever bosses (see Patent Literature 2). A lever is pivotally moved while the lever bosses are retainingly engaged respectively with retaining bosses formed on a mating connector, and by doing so, the fitting of the lever-fitting connector to the mating connector proceeds.

Patent Literature 1: JP-A-2003-249304 (Paragraph 0017, Paragraph 0022, FIG. 5, etc.)

Patent Literature 2: JP-A-2005-122942 (Paragraph 0078, FIG. 17, etc.)

However, there have been proposed various lever-fitting type connectors, and depending on the construction of the housing, much time has often been required for mounting the lever on the housing because of the lever bosses projecting laterally or perpendicularly from the lever-inserting direction.

For example, when the lever bosses move into the inside of the housing after the worker passes the lever bosses respectively through relief portions formed at lever-inserting surfaces of the housing, it is difficult to position the lever relative to the housing, and therefore much time has been required for the lever-mounting operation.

Even if the mounting grooves disclosed in the above Patent Literature 1 are merely applied to such a lever-fitting type connector, such mounting grooves often fail to effectively perform their function after the lever bosses move into the housing.

### SUMMARY OF THE INVENTION

It is an object of this invention to provide a lever-fitting type connector which can solve the above problem.

A lever-fitting type connector of a first aspect of the invention comprises a housing, connectable to a mating connector, and having an inwardly-projecting housing boss; and a lever, including an engagement portion engageable with the housing boss, and a lever boss for retaining engagement with a retaining portion formed on the mating connector, wherein a guide portion for guiding the insertion of the lever into the housing is formed at the lever, and a relief portion for the passage of the lever boss therethrough during the insertion is formed at the inside of the housing; wherein, at the time of starting the insertion of the lever into the housing, the distance between the guide portion and the housing boss is smaller than the distance between the lever boss and the relief portion.

The lever-fitting type connector of a second aspect of the invention is characterized in that the guide portion includes a groove portion extending from the engagement portion to a peripheral edge of the lever along a direction of inserting of the lever.

The lever-fitting type connector of a third aspect of the invention is characterized in that the guide portion includes a notch portion formed in that portion of the peripheral edge of the lever aligned with the engagement portion in the direction of inserting of the lever.

In the lever-fitting type connector of the present invention, at the time when the worker inserts the lever into the housing, the guiding of the insertion by the guide portion is started, and thereafter the lever boss begins to pass through the relief portion. The guiding of the insertion by the guide portion is started at an initial stage of the insertion, and therefore the worker can smoothly mounted the lever on the housing in a short time.

### BRIEF DESCRIPTION OF THE DRAWINGS

FIG. 1 A, B are perspective views showing a first embodiment of a lever-fitting type connector of the present invention and a mating connector.

FIG. 2 is an exploded perspective view of the lever-fitting type connector.

FIG. 3 A is a bottom view showing the manner of mounting a lever on a housing. FIG. 3B is a cross-sectional view taken along the line A-A of FIG. 3A

FIG. 4A is a top plan view showing the manner of fitting the lever-fitting type connector to the mating connector. FIG. 4B is a cross-sectional view taken along the line B-B of FIG. 4A.

FIG. 5 is a view showing the positional relationship of groove portions, a lever boss, etc.

FIG. 6 is an exploded perspective view of a second embodiment of a lever-fitting type connector of the invention.

FIG. 7 is a view showing the positional relationship of notch portions, a lever boss, etc.

FIG. 8A, B are views showing the manner of mounting a lever on a housing.

### DESCRIPTION OF THE PREFERRED EMBODIMENTS.

Preferred embodiments of the present invention will now be described with reference to the drawings.

### First Embodiment

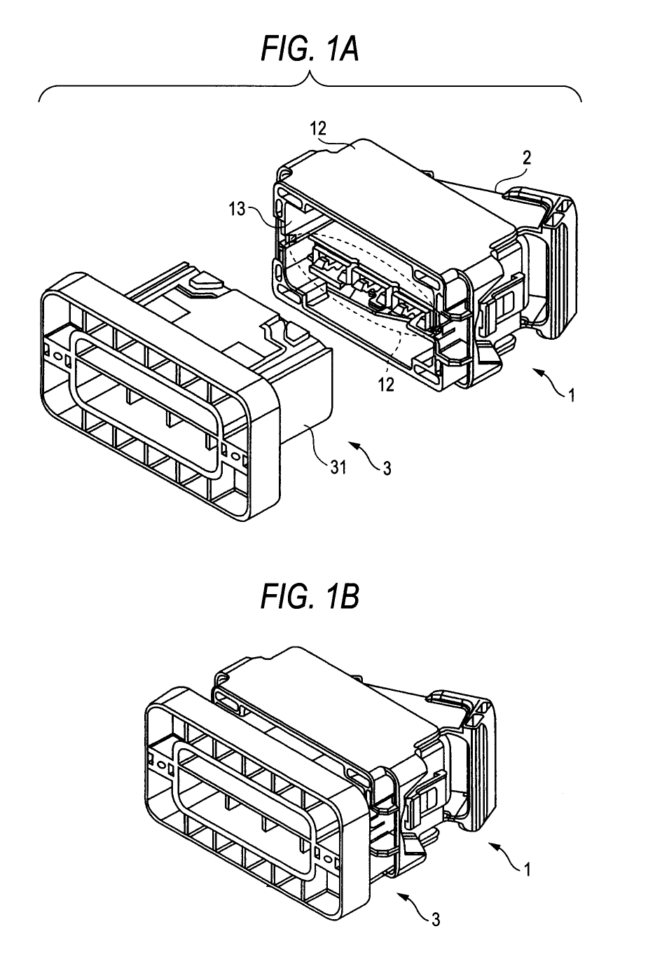

First, a first embodiment of a lever-fitting type connector of the invention as well as a mating connector will be briefly described. As shown in FIGS. 1A and 1B, the lever-fitting type connector 1 includes a female terminal-receiving portion 11, a housing 12, and a lever 2, and the mating connector 3 includes a male terminal-receiving portion (not shown), and a housing 31.

The female terminal-receiving portion 11 of the lever-fitting type connector 1 receives female terminals therein, and can be connected to the male terminal-receiving portion of the mating connector 3. A hood portion 13 is formed at the housing 12 in surrounding relation to the female terminal-receiving portion 11 so as to guide the fitting connection of this female terminal-receiving portion 11. The lever 2 can be pivotally moved relative to the housing 12 so as to assist the lever-fitting type connector 1 and the mating connector 3 to fit to each other (that is, to assist the female terminal-receiving portion 11 and the male terminal-receiving portion to fit to each other).

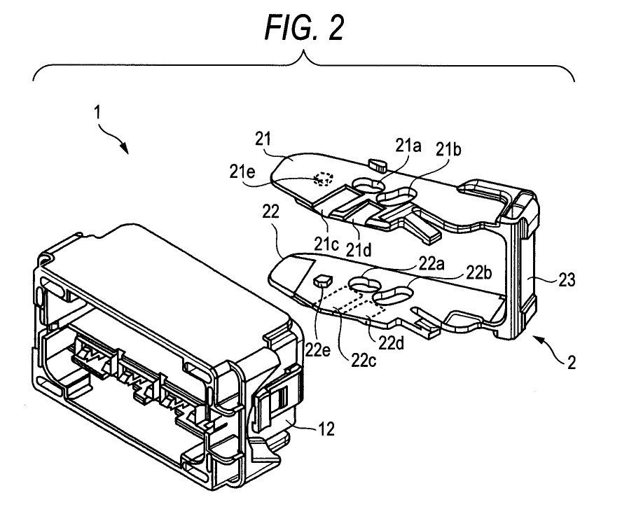

More specifically, the lever 2 includes flat plate-like members 21 and 22, and an interconnecting member 23 as shown in FIG. 2. Each of the flat plate-like members 21 and 22 is formed into a flat plate-shape so as to be inserted into a space or gap between the female terminal-receiving portion 11 and the hood portion 13. The interconnecting member 23 interconnects the flat plate-like members 21 and 22 opposed at their side faces to each other so that these flat plate-like members 21 and 22 can be simultaneously pivotally moved relative to the housing 12.

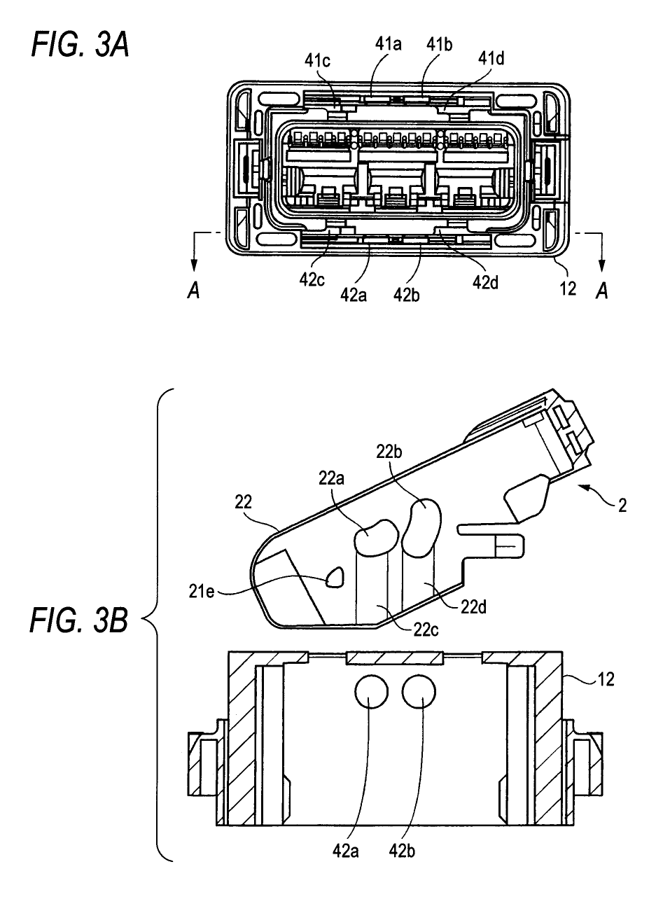

As shown in FIGS. 3A and 3B, the hood portion 13 of the housing 12 has housing bosses 41a, 41b, 42a and 42b, and the flat plate-like member 22 has engagement portions 22a and 22b (FIG. 3A is a bottom view of the housing 12, and FIG. 3B is a cross-sectional view taken along the line A-A of FIG. 3A).

The housing bosses 42a and 42b project inwardly from an inner peripheral surface of the hood portion 13 (that is, project from the reverse side to the front side in FIG. 3B). The engagement portions 22a and 22b are adapted to be engaged with the housing bosses 42a and 42b, respectively. Similarly, engagement portions 21a and 21b (FIG. 2) are formed at the flat plate-like member 21, and the housing bosses 41a and 41b are adapted to be engaged with the engagement portions 21a and 21b, respectively.

The engagement portions 21a and 21b are engaged respectively with the housing bosses 41a and 41b, and also the engagement portions 22a and 22b are engaged respectively with the housing bosses 42a and 42b, and as a result the lever 2 is supported on the housing 12 so as to be pivotally moved about the housing bosses 41a and 41b and the housing bosses 42a and 42b.

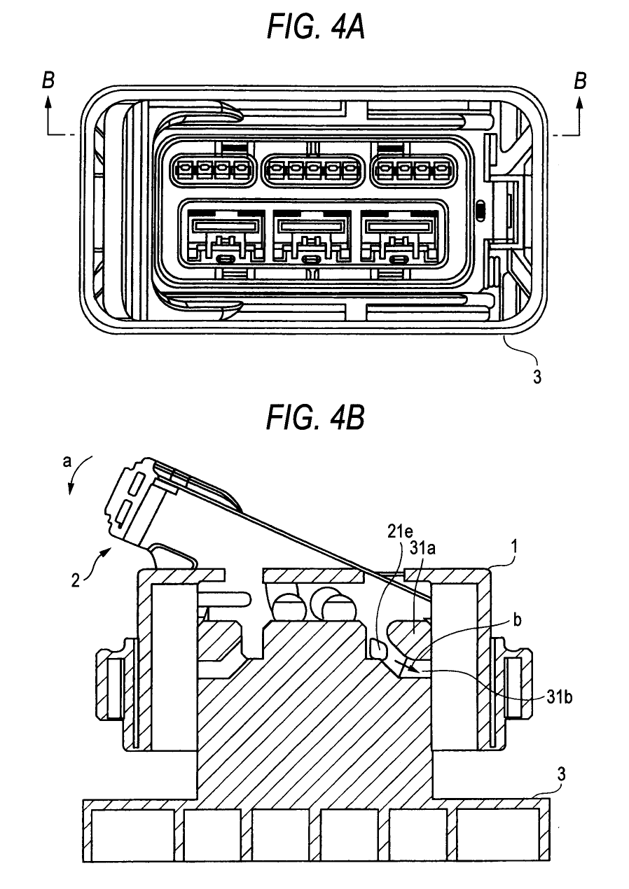

As shown in FIG. 4B, a lever boss 21e is formed at the lever 2, and retaining bosses 31a are formed at the mating connector 3 (FIG. 4A is a top plan view of the lever-fitting type connector 1, and FIG. 4B is a cross-sectional view taken along the line B-B of FIG. 4A. Each retaining portion is formed by the retaining boss 31a and a guide groove 31b (described later).). The worker fits the lever-fitting type connector 1 to the mating connector 3 to a certain degree, and then when the worker lowers the lever 2 in a direction of arrow a, the lever boss 21e moves in a direction of arrow b. Namely, the lever boss 21e, while pushing the retaining boss 31a upward, advances in and along the guide groove 31b, and therefore at this time the fitting of the lever-fitting type connector 1 to the mating connector 3 proceeds.

Then, the lever 2 is completely brought down, and the lever boss 21e reaches an inner end portion of the guide groove 31b, so that an upper surface of the lever boss 21e is retainingly engaged with a lower surface of the retaining boss 31a, and as a result the lever-fitting type connector 1 is moved or drawn toward the mating connector 3, so that the lever-fitting type connector 1 and the mating connector 3 are completely fitted together.

The structures of the lever-fitting type connector 1 and mating connector 3 as well as the fitting operation thereof are well known, and similar structures and fitting operation are described, for example, in JP-A-2005-122942.

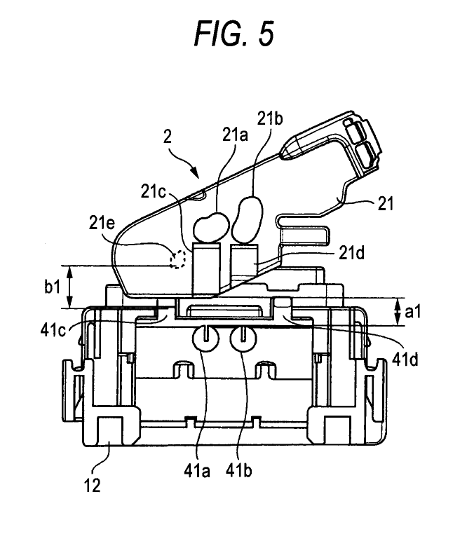

The present invention seeks to provide the structure in which the lever 2 can be easily inserted into the housing 12 in the process of producing the lever-fitting type connector 1. As shown in FIGS. 2 and 5, groove portions 21c and 21d are formed in the flat plate-like member 21 of the lever 2, and these groove portions 21c and 21d guide the insertion of the lever 2 relative to the housing bosses 41a and 41b at the time when the worker inserts the lever 2 into the housing 12.

Namely, the grooves portions 21c and 21d are one example of guide portions, and the groove portion 21c is formed in the flat plate-like member 21, and extends from the lower side of the engagement portion 21a to a lower edge (peripheral edge portion) of the flat plate-like member 21 along the direction of inserting of the lever 2. A width of the groove portion 21c corresponds to the diameter of the housing boss 41a, and a depth of the groove portion 21c is determined according to the height of the housing boss 41a.

Similarly, the groove portion 21d extends from the lower side of the engagement portion 21b. Further, groove portions 22c and 22d are also formed in the flat plate-like member 22 as described above for the flat plate-like member 21.

Further, relief portions 41c, 41d, 42c and 42d (FIG. 3A and FIG. 5) are formed at the housing 12. These relief portions 41c, 41d, 42c and 42d are spaces formed between the female terminal-receiving portion 11 and the hood portion 13. When inserting the lever 2 into the housing 12, the worker passes the lever boss 21e through one of the relief portions 41c and 41d, and also passes a lever boss 22e through that relief portion 42c, 42d which corresponds in position to the one relief portion 41c, 41d (through which the lever boss 21e passes). (In FIG. 3A, for example, walls disposed at the right and left sides of the relief portion 41c, 41d, that is, wall-like portions (contacting the lever 2) excluding the relief portions 41c, 41 d prevent the lever 2 from tilting inwardly.) One feature of the lever-fitting type connector 1 of the invention is the positional relation between the groove portion 21c, the housing boss 41a, the lever boss 21e and the relief portion 41c which is obtained at the time of starting the insertion of the lever 2 into the housing 12. Namely, as shown in FIG. 5, the various portions are formed such that the distance al between the lower end of the groove portion 21c and the upper end of the housing boss 41a is smaller than the distance b1 between the lower end of the lever boss 21e and the upper end of the relief portion 41c.

Because of this positional relationship of the various portions, the guiding by the groove portions 21c and 22c is initiated at the time of inserting the lever 2 into the housing 12, and the lever boss 21e begins to pass through the relief portion 41c, with the lever 2 prevented from moving in a direction perpendicular to the inserting direction. Therefore, the worker can more smoothly mount the lever 2 on the housing 12 in a shorter time.

For example, there can be prevented a disadvantageous situation in which it is difficult to position the lever 2 relative to the housing 12 after only the lever boss 21e is moved into the housing 12 through the relief portion 41c. The worker can smoothly mount the lever 2 on the housing 12 in a short time.

In this embodiment, the lever 2 is formed into the U-shape, and in other words the lever 2 comprises the flat plate-like members 21 and 22, and the interconnecting member 23 interconnecting the flat plate-like members 21 and 22, and in addition to the groove portions 21c and 22c, the groove portions 21d and 22d are formed. With this construction, the lever 2 can be guided more stably.

### Second Embodiment

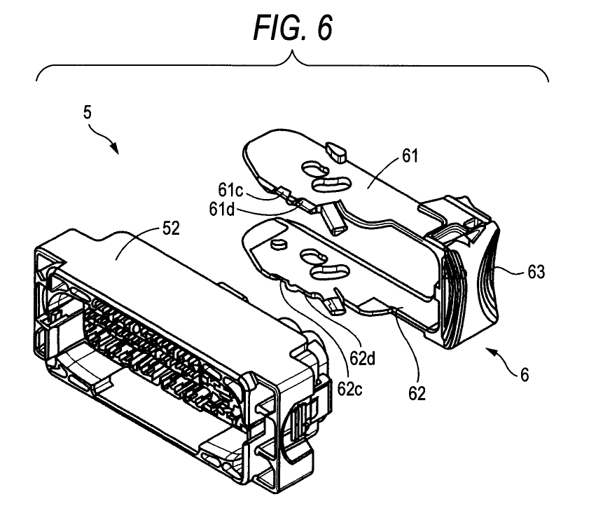

Next, a second embodiment of a lever-fitting type connector of the invention will be described. As shown in FIG. 6, this embodiment differs from the first embodiment in that instead of the groove portions 21c and 21d, notch portions 61c and 61d are formed at a lever 6, and also instead of the groove portions 22c and 22d, notch portions 62c and 62d are formed at the lever 6. This second embodiment is generally similar in construction, advantageous effects, etc., to the first embodiment except the construction, advantageous effects, etc., of the lever 6 described later.

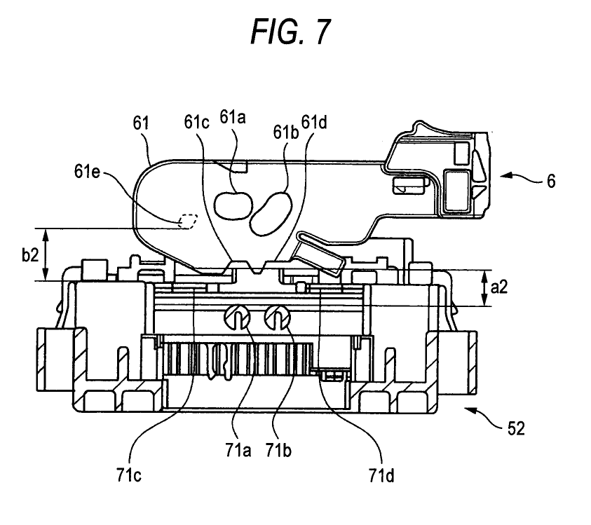

The lever-fitting type connector 5 comprises the lever 6, and a housing 52. The lever 6 includes flat plate-like members 61 and 62, and an interconnecting member 63 as in the first embodiment. As shown in FIG. 7, the flat plate-like member 61 has engagement portions 61a and 61b and the notch portions 61c and 61d.

The engagement portions 61a and 61b are adapted to be engaged respectively with housing bosses 71a and 71b formed on the housing 52, and the notch portions 61c and 61d are adapted to guide the insertion of the lever 6 into the housing 52.

The notch portions 61c and 61d are another example of the guide portions, and the notch portion 61c is formed in that portion of a lower edge (peripheral edge) of the flat plate-like member 61 aligned with the engagement portion 61a in a direction of inserting of the lever 6. The shape of this notch portion 61c is determined according to the shape of an upper portion of the housing boss 71a.

Similarly, the notch portion 61d is formed in that portion of the lower edge (peripheral edge) of the flat plate-like member 61 aligned with the engagement portion 61b in the direction of inserting of the lever 6. Similarly, the notch portions 62c and 62d are also formed in the flat plate-like member 62.

In this embodiment, at the time of starting the insertion of the lever 6 into the housing 52, the distance a2 between each notch portion 61c, 61d and the corresponding housing boss 71a, 71b is smaller than the distance b2 between a lower end of a lever boss 61e and an upper end of a relief portion 71c as shown in FIG. 7. Namely, the positional relation between the notch portions 61c and 61d, the housing bosses 71a and 71 b, the lever boss 61e and the relief portion 71c is so determined that at the time of inserting the lever 6 into the housing 52, the lever boss 61e can begin to pass through the relief portion 71c after the guiding by the notch portions 61c and 61d is initiated.

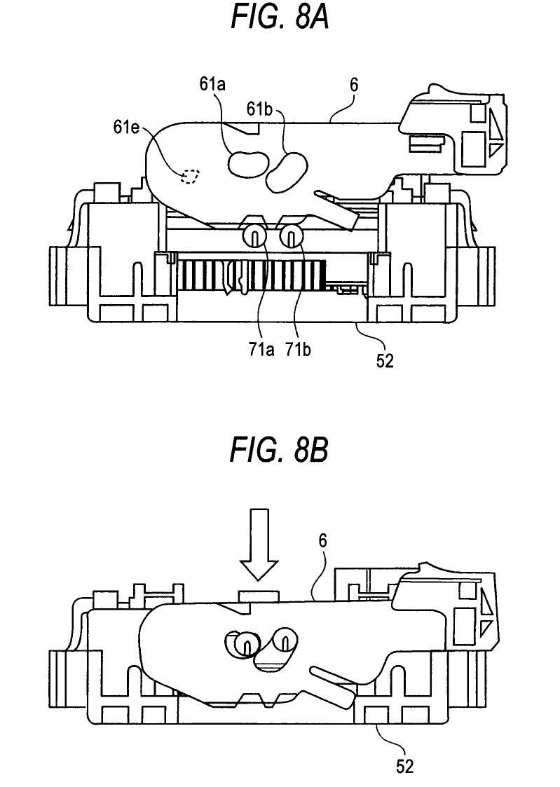

With this construction, a pushing force applied to the lever 6 by the worker concentrates on the vicinities of the upper ends of the notch portions 61c and 61d, and therefore the worker can fit the housing bosses 71a and 71b into the respective engagement portions 61a and 61b in one breath (FIG. 8A, and FIG. 8B). In accordance with this fitting operation, the lever boss 61e passes through the relief portion 71c at the upper portion of the housing 52 without particularly letting the worker be conscious of this.

In this embodiment, also, the lever 6 can be smoothly inserted into the housing 52 as in the preceding embodiment.

### Other Embodiments, etc.

Although the present invention has been described above by way of the specific embodiments, the invention is not limited to the above embodiments, and various modifications can be made without departing from the subject matter of the invention.

A. For example, although the engagement portions 21a, 21b, 22a, 22b and so on are each in the form of a through hole, each of these engagement portions may be in the form of a recessed portion deeper than the groove portions 21c, 21d, 22c and 22d.

B. Although the lever 2 is formed into the U-shape, using the two flat plate-like members 21 and 22, it may be replaced by a lever comprising a single flat plate-like-member.

C. Although the two engagement portions (for example, 21a and 21b) are formed in the flat plate-like member (21), only one engagement portion may be formed in the flat plate-like member.

D. Although the notch portion 61c, 61d has a trapezoidal shape or the shape defined by interconnected straight lines, it may have any other suitable shape such as a semi-circular shape and a semi-oval shape or may have a shape defined by interconnected curved lines.

E. Naturally, the groove portions and the notch portions may be formed at the lever. In this case, the lever can be more smoothly and stably mounted on the housing.

What is claimed is:

1. A lever-fitting type connector comprising:
a housing, connectable to a mating connector, and formed with an inwardly-projecting housing boss; and
a lever, including an engagement portion engageable with the housing boss, and a lever boss retaining engagement with a retaining portion formed on the mating connector;
wherein a guide portion guiding the insertion of the lever into the housing is formed at the lever, and a relief portion for the passage of the lever boss therethrough during the insertion is formed at the inside of the housing;
wherein, at the time of starting the insertion of the lever into the housing, the distance between the guide portion and the housing boss is smaller than the distance between the lever boss and the relief portion.

2. The lever-fitting type connector according to claim 1, wherein the guide portion includes a groove portion extending from the engagement portion to a peripheral edge of the lever along a direction of inserting of the lever.

3. The lever-fitting type connector according to claim 1, wherein the guide portion includes a notch portion formed in that portion of the peripheral edge of the lever aligned with the engagement portion in the direction of inserting of the lever.
